(19) United States
(12) Patent Application Publication
(10) Pub. No.: US 2015/0147616 A1
(43) Pub. Date: May 28, 2015

(54) BUTTON CELL CASINGS SUITABLE FOR NON-AQUEOUS CELLS

(71) Applicant: CORNELL UNIVERSITY, Ithaca, NY (US)

(72) Inventors: Katharine Rose Chemelewski, Austin, TX (US); Yong Lak Joo, Ithaca, NY (US)

(73) Assignee: CORNELL UNIVERSITY, Ithaca, NY (US)

(21) Appl. No.: 14/551,312

(22) Filed: Nov. 24, 2014

Related U.S. Application Data
(60) Provisional application No. 61/908,411, filed on Nov. 25, 2013.

(51) Int. Cl. H01M 10/0525; H01M 10/04; H01M 2/02

(52) U.S. Cl. CPC H01M 10/0525; H01M 2/0222; H01M 10/0431
USPC 429/94; 429/174

(57) ABSTRACT

Provided herein are button cell housing components configured to be suitable for lithium ion battery cells.

### CROSS-REFERENCE

This application claims the benefit of U.S. Provisional Application Nos. 61/908,411, filed on Nov. 25, 2013 and entitled “Button Cell Casings Suitable for Non-Aqueous Cells,” which is incorporated herein by reference in its entireties.

### BACKGROUND OF THE INVENTION

Batteries comprise one or more electrochemical cell, such cells generally comprising a cathode, an anode and an electrolyte. Lithium ion batteries are high energy density batteries that are fairly commonly used in consumer electronics and electric vehicles. In lithium ion batteries, lithium ions generally move from the negative electrode to the positive electrode during discharge and vice versa when charging. In the as-fabricated and discharged state, lithium ion batteries often comprise a lithium compound (such as a lithium metal oxide) at the cathode (positive electrode) and another material, generally carbon, at the anode (negative electrode).

### SUMMARY OF THE INVENTION

Provided in certain embodiments herein are battery cell components suitable for lithium ion battery cells. In specific embodiments, these battery cell components are small-format, e.g., button cell, components. In some instances, such components provides (i) hermetic sealing from the outside environment, (ii) structural and mechanical support for the cell walls, and (iii) an insulating barrier to prevent short circuit between the positive and negative electrode.

Provided in certain embodiments herein is a battery cell housing component comprising:
a. a body forming a wall of the housing component, the body comprising an inner surface and an outer surface;
b. a lid end, the lid end being joined with the body at a body-lid juncture, the lid end enclosing one end of the housing component, the lid end comprising an inner surface and an outer surface;
c. an open end (also referred to herein as a receiving end—such as for receiving electrode, separator, and/or electrolyte components within the housing component), formed at the termination of the body, opposite the lid end (e.g., providing an open base of the housing component); and
d. a housing seal positioned on the surface of the cell housing.

In certain embodiments, the housing seal comprises:
a. an inner surface seal body on at least a portion of the inner surface of the body;
b. a base seal body on the termination of the body;
c. an outer surface seal body on at least a portion of the outer surface of the body;
d. a outer-junction seal body on the outer surface at the body-wall junction; and/or
e. a lid seal body on at least a portion of the outer surface of the lid end.

In specific embodiments, the housing seal comprises:
a. a base seal body on the termination of the body; and
b. an outer surface seal body on at least a portion of the outer surface of the body.

In more specific embodiments, the housing seal comprises:
a. an inner surface seal body on at least a portion of the inner surface of the body;
b. a base seal body on the termination of the body;
c. an outer surface seal body on at least a portion of the outer surface of the body;
d. a outer-junction seal body on the outer surface at the body-wall junction; and
e. a lid seal body on at least a portion of the outer surface of the lid end.

In certain embodiments, the battery cell housing component is a button cell housing component. In specific embodiments, the button cell housing component is a button cell lid.

In some embodiments, the cell housing is any suitable shape, such as cylindrical. In certain embodiments, he housing component has an outer dimension (e.g., diameter) of 25 mm or less. In some embodiments, the housing component has an outer dimension (e.g., diameter) of 10 mm or less. In specific embodiments, the housing component has an outer dimension (e.g., diameter) of about 7.2 mm to about 7.6 mm (e.g., about 7.3 mm or 7.27 mm) (e.g., for a size 13 or 312 button cell lid). In some embodiments, the housing component has height (e.g., dimension of the wall height plus any top protrusion) of 10 mm or less. In some embodiments, the housing component has a height of about 3.2 mm to about 3.4 mm (e.g., about 3.3 mm) (e.g., for a size 312 button cell lid). In other embodiments, the housing component has a height of about 5 mm to about 5.3 mm (e g , about 5 mm or 5.04 mm) (e.g., for a size 13 button cell lid).

In certain embodiments, the inner surface seal body covers at least 50% of the inner surface of the body. In further or additional embodiments, the inner surface seal body covers the inner surface of the body and abuts the inner surface of the lid end. In further or additional embodiments, the inner surface seal body covers the lower 50% of the inner surface of the body (i.e., the half of the inner surface of the body proximal to the termination end and distal to the lid end). In further or additional embodiments, the lid seal body covers less than 50% of the outer surface of the lid end.

In certain embodiments, the lid end comprises a lid end protrusion, the lid end protrusion being raised from the lid end, and the outer surface of the lid end comprising a recessed lid outer surface, a protrusion wall outer surface, and a protrusion top outer surface. In some embodiments, the lid seal body covers the recessed lid outer surface abuts the lid protrusion wall. In further or additional embodiments, the lid seal body covers less than 5% (e.g., none) of the outer surface of the protrusion top.

In further or additional embodiments, the housing seal covers less than 25% of the inner surface of the lid. In further or additional embodiments, the base seal body covers at least 95% of the termination of the body. In further or additional embodiments, the outer-junction seal body covers at least 95% of outer surface at the body-wall junction.

In various embodiments, the housing body and lid end comprise any suitable material. In specific embodiments, the housing body and lid end both comprise stainless steel (e.g., of any suitable gauge).

In various embodiments, the housing seal comprises any suitable material. In specific embodiments, the housing seal comprises a non-conductive or insulating polymer. In some embodiments, the housing seal comprises a polyolefin, such as polyethylene (PE) or polypropylene (PP).

In some embodiments, the battery cell housing component is configured with a second battery cell housing component, such as to assemble a battery cell (e.g., a lithium ion battery cell). In some embodiments, manufacture of the battery cell (e.g., lithium ion battery cell) comprises:
a. providing a first battery cell housing component as described herein;
b. providing a second battery cell housing component comprising
   i. a body forming a wall of the housing component, the body comprising an inner surface and an outer surface;
   ii. a base end, the base end being joined with the body at a body-base juncture, the base end enclosing one end of the housing component, the base end comprising an inner surface and an outer surface; and
   iii. an open end (also referred to herein as a receiving end—such as for receiving the first housing component), formed at the termination of the body, opposite the base end (e.g., providing an open top of the housing component); and
c. inserting the first battery cell housing component into the second battery cell housing component.

In some embodiments, the process further comprises contacting the housing seal of the first housing component (e.g., the a base seal body thereof) with the inner surface of the base end of the second housing component. In some embodiments, the process further comprises crimping the body of the second housing component over the housing seal of the first housing component (e.g., over the outer-junction seal body of the first housing component and, optionally, over at least a portion of the lid seal body of the first housing component—such as illustrated in the figures). In certain instances, crimping holds the first housing component in place and, e.g., hermetically sealing the inner chamber formed between the first and second housing components.

In certain embodiments, the process further comprises placing a positive electrode, a negative electrode, and a separator in the first housing component (e.g., prior to assembly with the second housing component).

In some embodiments, provided herein is a battery cell (e.g., a lithium ion battery cell) comprising the housing component or components described herein. In some embodiments, the battery cell comprises a first housing component and a second housing component as described herein. In certain embodiments, the housing seal of the first component is in contact with the inner surfaces of the base and body of the second component (e.g., forming a hermetic seal for the inner chamber formed therebetween).

In certain embodiments, the first component is placed inside the second battery cell housing component. In some embodiments, the body of the second housing component is crimped over the housing seal of the first housing component (e.g., over the outer-junction seal body of the first housing component and, optionally, over at least a portion of the lid seal body of the first housing component). In certain instances, crimping holds the first housing component in place and, e.g., hermetically sealing the inner chamber formed between the first and second housing components.

In some embodiments, the base seal body, the outer surface seal body, and the outer-junction seal body are in contact with the second battery cell housing. In further or alternative embodiments, the lid seal body is in contact with the second battery cell housing.

In certain embodiments, within an interior chamber formed between the first and second battery cell housing components, is a negative electrode, a separator, a positive electrode, and an electrolyte. In certain embodiments, any suitable configuration of the electrode and separators are utilized. Generally, the positive electrode is in contact with (e.g., in direct contact with or in contact with via a current collector, such as aluminum or copper) one of the first or second housing components and the negative electrode is in contact with (e.g., in direct contact with or in contact with via a current collector, such as aluminum or copper) the other of the first or second housing components. In some instances, the housing seal provides an insulating barrier to prevent short circuit between the positive and negative electrode. In certain embodiments, the electrode and separators are configured in a multi-layered, rolled-configuration within the inner chamber formed between the first and second housing components.

In some embodiments, the negative electrode, the separator and the positive electrode are configured in a multilayered, rolled configuration. In certain embodiments, the multi-layered rolled configuration comprises a first layer comprising a separator material, a second layer comprising a positive electrode material, a first surface of the second layer being in proximal relation to a first surface of the first layer, a third layer comprising a negative electrode material, a first surface of the third layer being in proximal relation to a second surface of the first layer, and a fourth layer comprising a separator material, a first surface of the fourth layer being in proximal relation to a second surface of the second layer, or a second surface of the third layer.

In some embodiments, the negative electrode material comprises any suitable material such as carbon, silicon, tin, and/or tin oxide. In some embodiments, the negative electrode material comprises a composite comprising silicon and carbon. In some embodiments, the negative electrode material comprises composite nanofiber(s), the composite nanofiber(s) comprising (non-aggregated) silicon nanoparticles embedded in a carbon matrix.

In certain embodiments, the positive electrode material comprises any suitable material, such as a lithium containing material. In specific embodiments, the positive electrode material comprises lithium metal oxide or lithium metal phosphate. In more specific embodiments, the positive electrode material comprises nanostructures (e.g., nanofiber(s)), the nanostructures (e.g., nanofiber(s)) comprising a continuous matrix of a lithium metal oxide or lithium metal phosphate.

In some embodiments, the separator material comprises any suitable material. In some embodiments, the separator material comprises a porous material comprising polymer. In specific embodiments, the separator material is a stretched polymer film (e.g., of a polyolefin, such as polyethylene or polypropylene). In other specific embodiments, the separator material comprises polymer-containing nanofibers. In still more specific embodiments, the separator material comprises composite nanofiber(s), the composite nanofibers comprising nanostructured clay or ceramic embedded in a polymer matrix (e.g., polyacrylonitrile (PAN)).

In specific embodiments, the lithium ion battery is a small-format lithium ion battery cell. In specific embodiments, the small-format lithium ion battery cell is a button cell. In certain embodiments, the lithium ion battery cell has an aspect ratio (the ratio of the height to diameter) of ≦1.2. In specific embodiments, the aspect ratio is ≦1. In more specific embodiments, the aspect ratio is ≦0.5. In certain embodiments, the cell has a first dimension (e.g., diameter) of less than 25 mm and a rolled height of less than 10 mm.

In some embodiments, the battery cell has an energy density of at least 75 Wh/L. In more specific embodiments, the battery cell has an energy density of at least 300 Wh/L. In specific embodiments, such a cell diameter of about 7.9 mm and a cell height of about 3.6 mm, and comprising a capacity of at least 5 mAh. In further embodiments, such a cell diameter of about 7.9 mm and a cell height of about 5.4 mm, and comprising a capacity of at least 9 mAh.

In some embodiments, a multi-layered, rolled battery component provided within the housing components provided herein comprises a layered structure comprising at least three layers, the first layer being a separator layer, the second layer being an anode (or negative electrode) layer, and the third layer being a cathode (or positive electrode) layer. In certain embodiments, the separator layer is positioned between the anode (or negative electrode) layer and the cathode (or positive electrode) layer so as to reduce the incidence of short circuit. In further embodiments, the multi-layered battery component further comprises at least one additional separator layer, positioned on the externally facing surface (i.e., the surface not positioned in proximity to the separator layer positioned between the electrode layers) of the anode (or negative electrode) layer and the cathode (or positive electrode) layer. In some embodiments, the multi-layered battery component comprises at least five layers, the first layer being a separator layer, the second layer being an anode (or negative electrode) layer, the third layer being a cathode (or positive electrode) layer, the fourth layer being a separator layer, and the fifth layer being a separator layer. In some instances, the use a an additional (e.g., a second and optional third) separator layer on the external surface of one or more of the electrodes (e.g., the anode and/or cathode/positive and/or negative electrode) allows for rolling of multi-layered battery component, without brining the anode and cathode (or negative and positive electrodes) into contact with one another.

In some embodiments, the multi-layered battery component is a multi-layered lithium ion battery component. In some instances, the separator layer(s) comprise lithium ion battery separator layer(s), the second anode (or negative electrode) layer comprises a lithium ion battery anode (or negative electrode) layer—e.g., comprising carbon or carbon and silicon composite material(s), and the cathode (or positive electrode) layer comprises lithium ion battery cathode (or positive electrode) layer—e.g., comprising lithium metal oxide, lithium metal phosphate, or other suitable material.

In certain embodiments, anode (or negative electrode), cathode (or positive electrode), and/or separator layers comprise nanofiber material. In some instances, the use of such nanofiber materials provides flexibility to the multi-layered battery component, which facilitates rolling (e.g., tight rolling) of the multi-layered battery component. Further, in some instances, the use of nanofiber materials allows for the formation of thin layers, which may also facilitate the rolling (e.g., tight rolling) of the multi-layered battery component.

In some embodiments, the rolled layer battery component has an aspect ratio (the ratio of the height—excluding tabs—to diameter) of ≦1.2. In specific embodiments, the aspect ratio is ≦1. In more specific embodiments, the aspect ratio is ≦0.5. In certain embodiments, the rolled layered batter component has a rolled diameter of less than 25 mm and a rolled height of less than 10 mm. A concurrently filed patent application entitled HIGH CAPACITY LITHIUM ION BATTERY BUTTON CELLS, by the same applicant(s) further describes such rolled configuration electrode materials, and such disclosure is incorporated herein by reference in its entirety.

In some embodiments, the cathode (or positive electrode) layer comprises a lithium ion battery cathode (or positive electrode) material, e.g., a lithium containing material, such as a lithium metal oxide or a lithium metal phosphate. In some embodiments, the cathode material is a nanostructured cathode material, such as a nanofiber (e.g., comprising a continuous matrix material of a lithium containing material, such as lithium metal oxide), nanoparticle, or nanocrystal.

In certain embodiments, the cathode material comprises a lithium containing material of the following formula (I):

LiₐM_{b}X_{c} (I)

In certain embodiments, M represents one or more metal element (e.g., M represents Fe, Ni, Co, Mn, V, Ti, Zr, Ru, Re, Pt, Bi, Pb, Cu, Al, Li, or a combination thereof) and X represents one or more non-metal (e.g., X represents C, N, O, P, S, SO₄, PO₄, Se, halide, F, CF, SO₂, SO₂Cl₂, I, Br, SiO₄, B0₃, or a combination thereof) (e.g., a non-metal anion). In some embodiments, a is 1-5 (e.g., 1-2), b is 0-2, and c is 0-10 (e.g., 1-4, or 1-3).

In some embodiments, X is selected from the group consisting of O, SO₄, PO₄, SiO₄, BO₃. In more specific embodiments, X is selected from the group consisting of O, PO₄, and SiO₄. In certain embodiments, M is Mn, Ni, Co, Fe, V, Al, or a combination thereof.

In certain embodiments, a lithium material of formula (I) is LiMn₂O₄, LiNi_{1/3}Co_{1/3}Mn_{1/3}O₂, LiCoO₂, LiNiO₂, LiFePO₄, Li₂FePO₄F, or the like. In some embodiments, a lithium material of formula (I) is LiNi_{b1}Co_{b2}Mn_{b3}O₂, wherein b1+b2+b3=1, and wherein 0≦b1, b2, b3<1. In some embodiments, a lithium material of formula (I) is LiNi_{b1}Co_{b2}Al_{b3}O₂, wherein b1+b2+b3=1, and wherein 0<b1, b2, b3<1. In certain embodiments, a lithium material of formula (I) is LiMn₂O₄, LiMn_{b1}Fe_{b2}O₄ (wherein b1+b2=2, e.g., b1=1.5), LiMnPO₄, LiNiPO₄, LiCoPO₄, Li₃V₂(PO₄)₃, Li₂FeSiO₄, Li₂MnSiO₄, LiFeBO₃, or LiMnBO₃.

In some embodiments, the anode (or negative electrode) layer comprises a lithium ion battery anode (or negative electrode) material, e.g., a carbon, silicon, tin, tin oxide, or a combination thereof. In some embodiments, the anode (or negative electrode) material is a nanostructured anode (or negative electrode) material, such as a nanofiber (e.g., composite nanofibers comprising (non-aggregated) silicon nanoparticles embedded in a carbon matrix).

In some embodiments, the separator layer(s) comprise a lithium ion battery separator material. In specific instances, separator layer(s) independently comprise a porous polymer material (e.g., film or nanofiber mat). In certain embodiments, the separator layer(s) comprise porous materials independently comprising a polyolefin (e.g., polyethylene (PE) and/or polypropylene (PP)), polyvinylacetate (PVAc), polyvinylalcohol (PVA), polyacrylonitrile (PAN), or other suitable polymer. In specific embodiments, the porous material comprises a polyolefin (e.g., PE or PP) stretched film. For example, in some embodiments, a separator layer provided herein optionally comprises a Celgard Commercial Monolayer Polypropylene (PP) Separator, e.g., Celgard 2400, Celgard 2500, or Celgard PP2075, a Celgard Commercial Monolayer Polyethylene Separator, or a Celgard Commercial Trilayer PP/PE/PP Separator (e.g., 2325, 2320, C210, M825, M1473, M824, or the like). In further or alternative embodiments, the porous material comprises a nanofiber mat comprising nanofibers having a matrix of polyvinylacetate (PVAc), polyvinylalcohol (PVA), polyacrylonitrile (PAN), or other suitable polymer. In some embodiments, the porous polymer material (e.g., nanofibers mats) comprises (i) polymer and (ii) clay, ceramic, or a combination thereof (e.g., nanocomposite nanofibers comprising clay and/or ceramic nanostructures embedded in a polymer matrix). In some embodiments, such separators comprise nanofibrous mats comprising polymer nanofibers and composite nanofibers, e.g., as set forth in U.S. Pat. No. 7,083,854, which is incorporated herein for such disclosure. Further, a separator layer provided herein optionally comprises multiple sub-layers comprising one or more of these types of separators.

In specific instances, the cell is a size 312 (e.g., a cell having a diameter of about 7.9 mm and a height of about 3.6 mm) secondary lithium ion battery cell and has an energy density of at least 5 mAh. In specific instances, the cell is a size 312 (e.g., a cell having a diameter of about 7.9 mm and a height of about 3.6 mm) secondary lithium ion battery cell and has an energy density of about 6 mAh, or more. In some embodiments, such cells comprise a housing component described herein and a rolled, multi-layered battery component wherein the cathode (or positive electrode layer) comprises nanostructured lithium material (e.g., nanostructured lithium metal oxide) and the anode comprises composite nanofibers comprising (non-aggregated) silicon nanoparticles embedded in a carbon matrix.

In specific embodiments, the cell is a size 13 (e.g., a cell having a diameter of about 7.9 mm and a height of about 5.4 mm) secondary lithium ion battery cell and has an energy density of at least 9 mAh. In specific instances, the cell is a size 312 (e.g., a cell having a diameter of about 7.9 mm and a height of about 5.4 mm) secondary lithium ion battery cell and has an energy density of about 10 mAh, or more. In some embodiments, such cells comprise a housing component described herein and a rolled, multi-layered battery component wherein the cathode (or positive electrode layer) comprises nanostructured lithium material (e.g., nanostructured lithium metal oxide) and the anode comprises composite nanofibers comprising (non-aggregated) silicon nanoparticles embedded in a carbon matrix.

In some embodiments, the discharge capacity of a cell provided herein is at least 80% of initial or second cycle capacity after 20 cycles. In more specific embodiments, the discharge capacity of a cell provided herein is at least 90% of initial or second cycle capacity after 20 cycles.

In the current market for small-format batteries, the commercialized technology has generally been for non-rechargeable primary cells with zinc-air chemistry. The casings available for these 312 and 13 cells were therefore not designed for application with non-aqueous systems, which require a seal that prohibits leakage of air (including, e.g., moisture) into the cell. Additionally, the conventional lid manufactured for these form factors do not generally extend throughout the full height of the casing, creating further issues with uniform sealing properties. Generally, when the conventional zinc-air casing is utilized in the fabrication of a Li-ion or non-aqueous battery, the result is leakage of the hazardous electrolyte solution through the sealing interface.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a schematic of a cross-section of an exemplary battery housing component provided herein.

FIG. 2 illustrates a schematic of an exemplary battery housing component provided herein, wherein the housing seal covers only a portion of the inner surface of the housing body and a portion of the recessed lid outer surface.

FIG. 3 illustrates a schematic of an exemplary battery cell comprising an exemplary battery housing provided herein assembled with a second battery housing, and enclosing in an inner chamber between the two battery housings an exemplary rolled-multilayered electrode/separator component.

FIG. 4 illustrates an image of a conventional casing assembled into a non-aqueous cell. Significant corrosion is observed.

FIG. 5 illustrates schematics of (a) cross sectional view of the 312-format lid, (b) cross sectional view of the 13-format lid, and (c) an overview of the lid design.

FIG. 6 illustrates an image of an assembled 312 button cell having a housing component described herein, assembled inside a second housing component.

FIG. 7 illustrates cycling data obtained for a 312 button cell having a housing component described herein assembled inside a second housing component. Good cyclability is observed over at least 20 cycles.

### DETAILED DESCRIPTION OF THE INVENTION

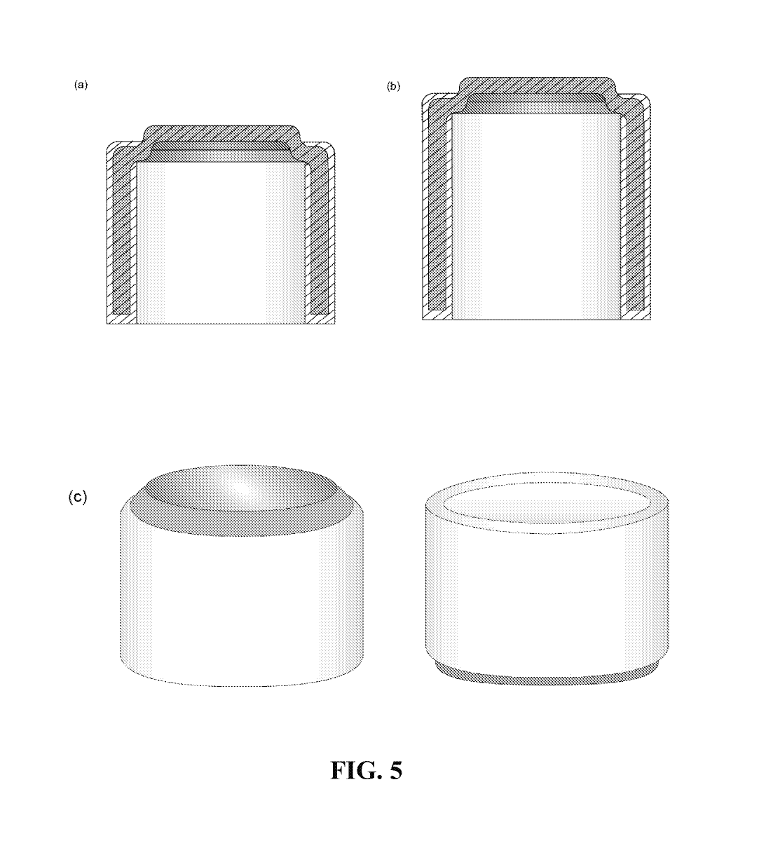

Non-limiting exemplary descriptions of the battery cell housing components, battery cells, and processes provided herein are illustrated in the figures. In some instances, the housing comprises a cup-shaped core (e.g., stainless steel) partially surrounded by a non-conductive material (e.g., a polypropylene plastic or any other non-conductive polymer material). Various cross sectional views of exemplary designs are illustrated in the figures. To accommodate different form factors, multiple heights and diameters of casings are optionally utilized. e.g., as illustrated by FIG. 5. Generally, the diameter and height of the lid are configured to corresponding with a bottom can (e.g., a standard button cell form factor bottom can). In some instances, the non-conductive material covers the outer wall surface and the wall termination (the bottom of the housing).

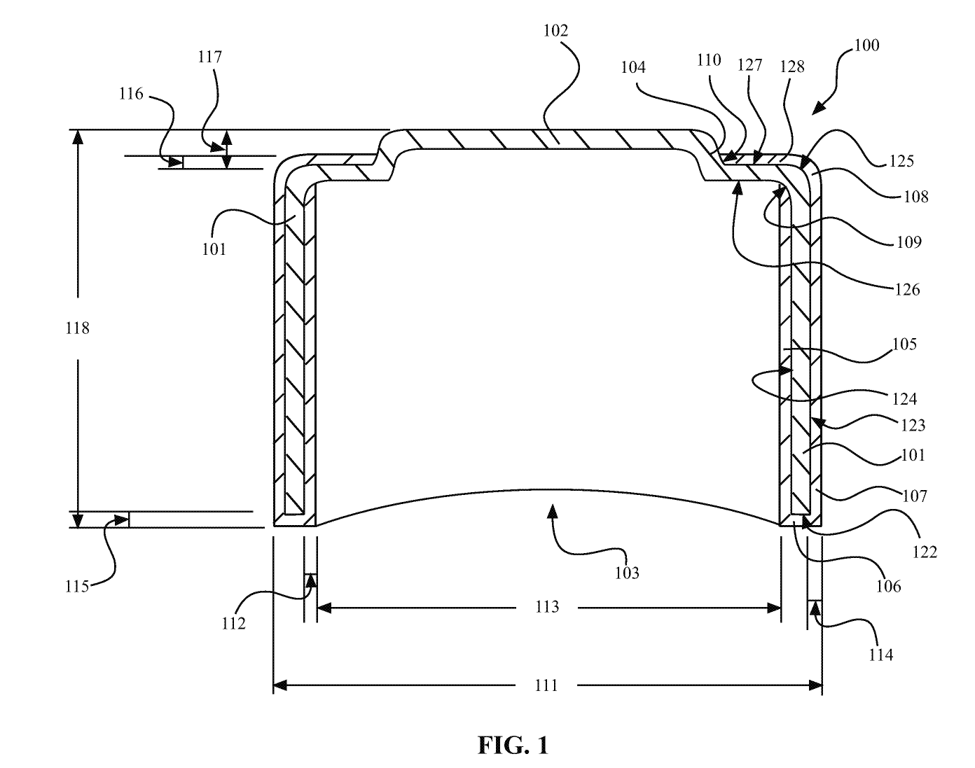

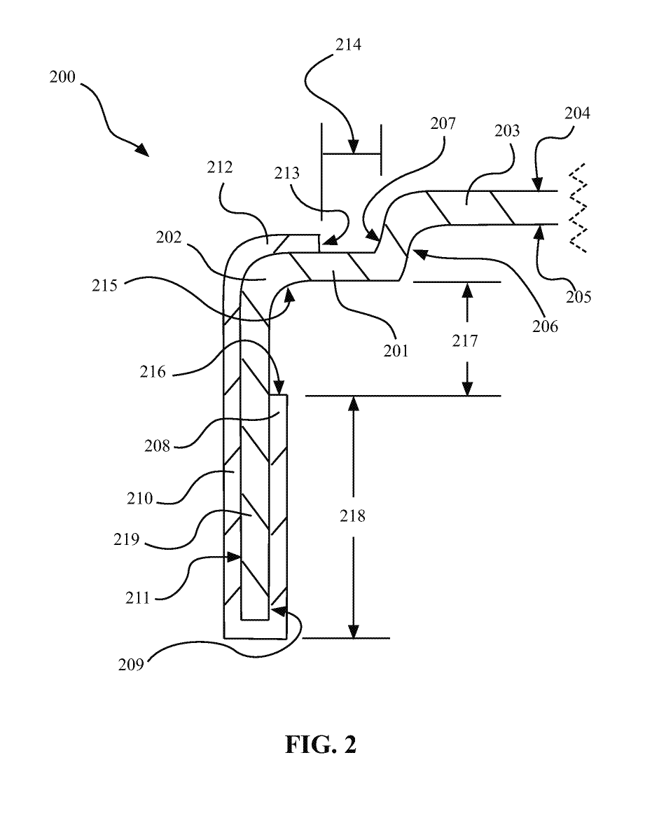

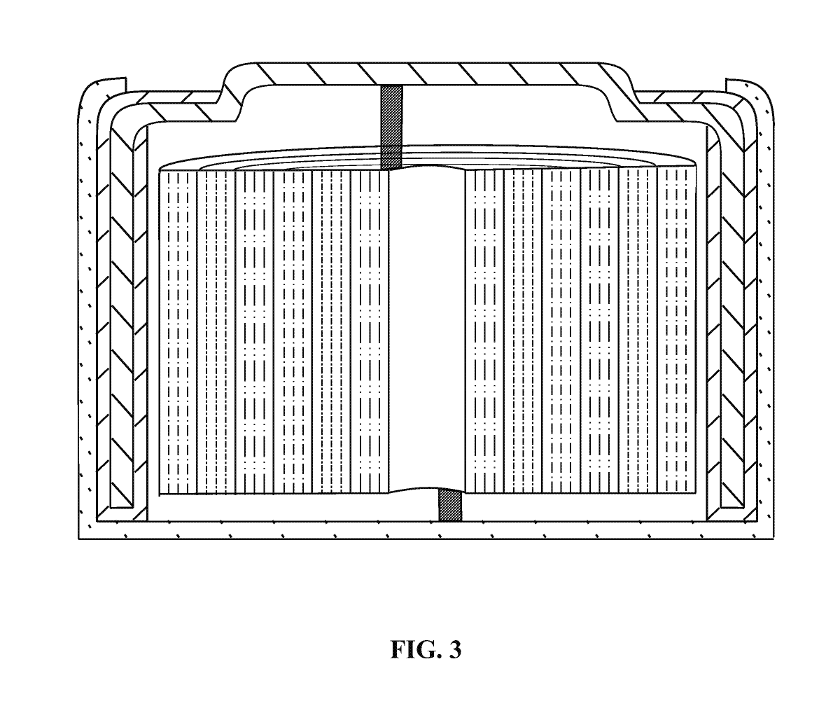

FIG. 1 illustrates a cross section of an exemplary battery cell housing component 100 provided herein. In some embodiments, the housing comprises a body forming a wall 101 of the housing component 100 and a lid end 102 joined with the body at the body-lid juncture 109. The body comprises an inner surface 124 and an outer surface 123. The lid end comprises an inner surface 126 and an outer surface 127. Opposite the lid end, an open (receiving) end 103 is optionally formed at the termination of the body 122. Within the receiving end 103, battery components, such as electrodes, separators, electrolyte and the like may be inserted into the housing component upon assembly of a battery cell. Further, the housing component generally comprises a housing seal. In some instances, the housing seal comprises an inner surface seal body 105 on the inner surface of the body 124. In specific instances, the inner surface seal body 105 optionally covers the entire inner surface of the body 124, abutting the inner surface of the lid-end 126, e.g., as illustrated in FIG. 1. In other instances, the inner surface seal body optionally covers a portion of the inner surface of the body 124 (e.g., at least 10% of the inner surface), e.g., as illustrated in FIG. 2. In some instances, the inner surface seal body 105 covers at least the lower portion of the inner surface of the body 124. In certain instances, the housing seal comprises a base seal body 106 that covers at least a portion of the termination of the body 122. In some instances, the housing seal comprises an outer surface seal body 107 that covers at least a portion of the outer surface of the body 123. In some instances, the housing seal covers the entire outer surface of the body, and curves over the outer surface of the body-lid junction 125, forming an outer-junction seal body 108. In addition, the housing seal optionally further covers a portion of the outer lid surface 127, forming a lid seal body 128. In certain embodiments, the housing lid end comprises a lid end protrusion 102, a lid end recess (e.g., at 127), and a protrusion wall 104, with an outer surface 110. In some instances, the lid end protrusion is raised from the lid end by an amount 117, and the outer surface of the lid end comprising a recessed lid outer surface, a protrusion wall outer surface 110, and a protrusion top outer surface. In some instances, the lid end protrusion is raised 117 by a greater amount than the thickness of the lid seal body 116. In certain instances, the lid seal body covers at least a portion of the recessed lid outer surface, optionally abutting the protrusion wall outer surface. In some embodiments, the housing seal is absent from the protrusion outer surface so as to provide electrical contact for the battery. In some instances, the inner surface seal body 105 has a thickness 112, the base seal body 106 has a thickness 115, the outer surface seal body 107 has a thickness 114 and the lid surface seal body 128 has a thickness 116. Any suitable thickness (e.g., to form a hermetic seal of an inner chamber formed by combing complimentary housing chambers, such as illustrated in FIG. 3) may be used for any of these seal bodies, and the thicknesses may be the same or different. In some instances, the thickness of each seal body is less than 1 mm, e.g., 0.1 mm to 1 mm, less than 0.7 mm, less than 0.5 mm, or the like. In some embodiments, the housing has a first outer dimension (e.g., diameter) 111, e.g., an outer diameter of less than 25 mm, e.g., less than 10 mm Such a dimension is any suitable dimension for the desired battery size. In some instances, e.g., for size 13 or 312 batteries, the diameter 111 is optionally 7 mm to 7.5 mm, e.g., about 7.3 mm or 7.27 mm In some instances, the inner dimension (e.g., diameter) 113 is any suitable diameter as well, and will depend on the thickness of the body walls and the thickness of the inner and outer surface seal bodies. In some instances, e.g., for size 13 or 312 batteries, the inner diameter 113 is optionally 5 mm to 6 mm. In some instances, the inner diameter is about 5.3 mm to about 5.7 mm, e.g., about 5.6 mm or 5.58 mm. In some instances, the housing component also has a height dimension 118, including the height of the body and any lid protrusion, if present. In some instances, such a dimension is less than 10 mm. In specific instances, the dimension is about 2.5 mm to about 6 mm. In more specific embodiments, the dimension is about 3 mm to about 3.5 mm (e.g., about 3.3 mm), or about 4.9 mm to about 5.2 mm (e g , about 5 mm or 5.04 mm).

FIG. 2 illustrates a portion of a cross section of an exemplary battery cell housing component 200 provided herein. In some embodiments, the housing comprises a body forming a wall 219 of the housing component 200 and a lid end 201 joined with the body at the body-lid juncture 202. The body comprises an inner surface 209 and an outer surface 211. The lid end comprises an inner surface 205 and an outer surface 204. Further, the housing component generally comprises a housing seal. In some instances, the housing seal comprises an inner surface seal body 208 on the inner surface of the body 209. In specific instances, the inner surface seal body 208 optionally covers a portion of the inner surface of the body 209. In some instances, the inner surface seal body 208 runs from the body termination up the inner surface of the wall by an amount 218. In some instances, the inner surface seal runs at least 10% (at least 20%, at least 50%, or the like) of they way of the inner surface of the body. In such instances, the inner surface seal body generally does not abut the inner surface body-lid junction 215, e.g., terminating at a distance 217 from the inner surface of the lid or body-lid junction 215. In certain instances, the housing seal comprises a base seal body that covers at least a portion of the termination of the body. In some instances, the housing seal comprises an outer surface seal body 210 that covers at least a portion of the outer surface of the body 211. In some instances, the housing seal covers the entire outer surface of the body, and curves over the outer surface of the body-lid junction, forming an outer-junction seal body. In addition, the housing seal optionally further covers a portion of the outer lid surface, forming a lid seal body 212. In certain embodiments, the housing lid end comprises a lid end protrusion 203, a lid end recess (e.g., at 201), and a protrusion wall, with an outer surface (e.g., at 204) and inner surface (e.g., at 205). In certain instances, the lid seal body covers at least a portion of the recessed lid outer surface, optionally terminating 213 short of the outer lid protrusion wall surface 207, by an suitable distance 214—e.g., a distance that allows maintenance of a hermetic seal. In some embodiments, the housing seal is absent from the protrusion outer surface so as to provide electrical contact for the battery.

FIG. 3 illustrates a cross-section of first housing component provided herein assembled with a second housing component. In some instances, the second housing component comprises a body forming a wall of the housing component, the body comprising an inner surface and an outer surface, a base end, the base end being joined with the body at a body-base juncture, the base end enclosing one end of the housing component, the base end comprising an inner surface and an outer surface; and an open end (also referred to herein as a receiving end—such as for receiving the first housing component), formed at the termination of the body, opposite the base end (e.g., providing an open top of the housing component). In some instances, the first housing component is positioned inside the second housing component, with the housing seal of the first housing component in contact with the second housing component. In particular, in some instances the base seal body of the first housing component is in contact with the inner surface of the base end of the second housing component. FIG. 3 also illustrates inclusion of rolled, multi-layered electrode component within an inner chamber formed by assembling the first housing component within the second housing component.

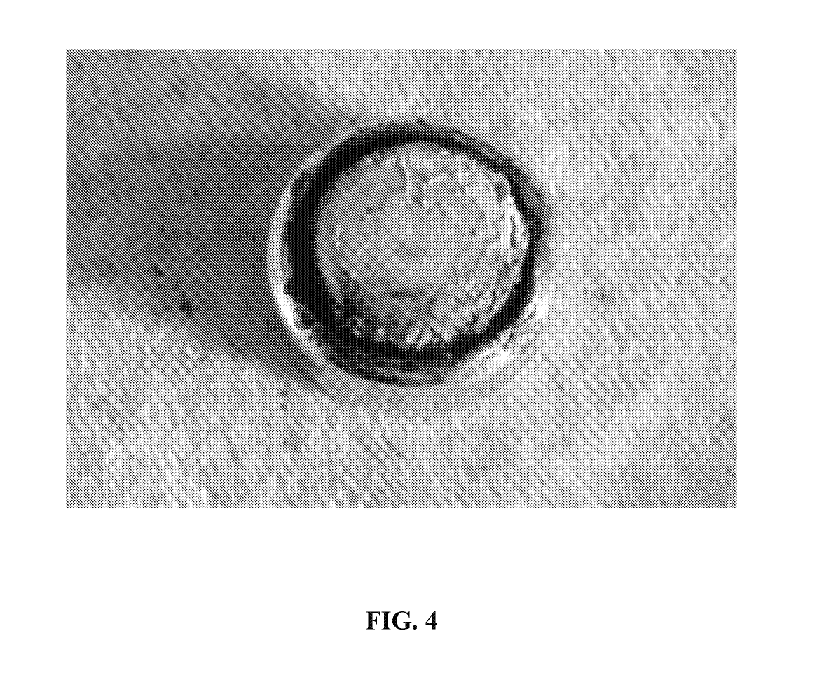

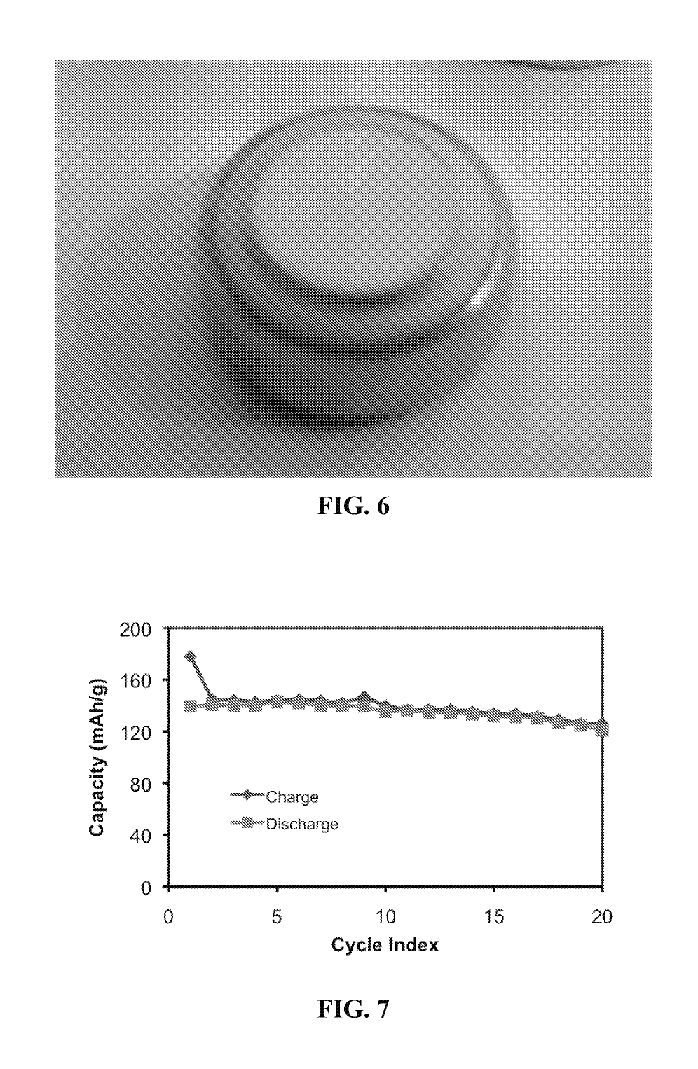

FIG. 4 illustrates a non-aqueous battery assembled without the housing seal as described herein. After time, the button cell casing demonstrated significant corrosion. FIG. 6 illustrates a non-aqueous battery prepared utilizing a housing component having a housing seal as described herein (assembled into a second housing, also as described herein). As can be seen by the image, corrosion is not observed in the battery illustrated in FIG. 6.

FIG. 5 illustrates schematics of (a) and (b) cross sectional view of housing having different heights (e.g., of the 312-format and 13-format lids, respectively), and (c) an overview of the lid design. Generally, the lighter portion corresponds to the housing seal and darker portions correspond to the housing body and/or lid. In panels (a) and (b), cross sections are illustrated, so the housing body and lid are both observed, whereas in the exemplary housing illustrated in panel (c), the housing body is not observed because the outer wall surface and bottom (as well as at least a portion of the inner wall surface) are covered with the housing seal.

FIG. 7 illustrates the good cyclability of a lithium ion battery assembled using a cell housing as described herein. In some embodiments, the % retention of a cell provided herein is at least (or at least 90% of) that illustrated in the figure (e.g., after a given cycle). Further, in certain embodiments, the capacity of a cell provided herein is at least (or at least 90% of) the capacity illustrated in the figure (e.g., initial capacity and/or capacity after a given cycle).

### EXAMPLES

### Example 1

Using a 312 battery casing comprising a stainless steel lid and body, with polypropylene seal around the outside and on the base thereof, a lithium ion button cell FIG. 6 was prepared using a carbon-silicon composite anode, a lithium metal oxide (Li-NMC) cathode, and a polyolefin separator in a rolled configuration as illustrated in FIG. 3. Cycling data was obtained for the battery, as illustrated in FIG. 7, which illustrates good cyclability of a small format lithium ion battery using a housing component described herein.

What is claimed is:

1. A battery cell housing component 100 comprising:
a. a body forming a wall 101, 219 of the housing component 100, 200, the body comprising an inner surface 209 and an outer surface 211;
b. a lid end 102, 201, the lid end being joined with the body 101, 219 at a body-wall juncture 109, 202, the lid end enclosing one end of the housing component, the lid end comprising an inner surface 126 and an outer surface 127;
c. an open end 103, formed at the termination of the body 122, opposite the lid end and providing an open base of the housing component; and
d. a housing seal positioned on the surface of the cell housing, the housing seal comprising:
i. an inner surface seal body 105, 208 on at least a portion of the inner surface of the body 124, 209;
ii. a base seal body 106 on the termination of the body 122;
iii. an outer surface seal body 107, 210 on at least a portion of the outer surface of the body 123, 211;
iv. a outer-junction seal body 108, 212 on the outer surface at the body-wall junction 125; and
v. a lid seal body 128 on at least a portion of the outer surface of the lid end 127.

2. The battery cell housing component of claim 1, wherein the battery cell housing component is a button cell housing component.

3. The battery cell housing component of claim 2, wherein the button cell housing component is a button cell lid.

4. The battery cell housing of claim 3, wherein the housing component has an outer diameter of 25 mm or less.

5. The battery cell housing of claim 4, wherein the housing component has an outer diameter of about 7.2 mm to about 7.6 mm.

6. The battery cell housing of claim 1, wherein the housing component has a height of 10 mm or less.

7. The battery cell of claim 6, wherein the housing component has a height of about 3.2 mm to about 3.4 mm.

8. The battery cell housing of claim 7, wherein the housing component has a height of about 5 mm to about 5.3 mm.

9. The battery cell housing of claim 1, wherein the inner surface seal body covers at least 50% of the inner surface of the body.

10. The battery cell housing of claim 9, wherein the inner surface seal body covers the inner surface of the body and abuts the inner surface of the lid end.

11. The battery cell housing of claim 10, wherein the inner surface seal body covers the lower 50% of the inner surface of the body.

12. The battery cell housing of claim 1, wherein the lid end comprises a lid end protrusion, the lid end protrusion being raised from the lid end, and the outer surface of the lid end comprising a recessed lid outer surface, a protrusion wall outer surface, and a protrusion top outer surface.

13. The battery cell housing of claim 1, wherein the housing seal covers less than 25% of the inner surface of the lid.

14. The battery cell housing of claim 1, wherein the housing body and lid end comprise steel.

15. The battery cell housing of claim 1, wherein the housing seal comprises polyethylene or polypropylene.

16. A lithium ion button cell comprising (i) as a first battery cell housing component, a battery cell housing component of claim 1, and (ii) a second battery cell housing component, wherein the first battery cell housing component is positioned inside the second battery cell housing component.

17. The lithium ion button cell of claim 16, wherein the housing seal is in contact with the second battery cell housing component, hermetically sealing an interior chamber formed between the first and second battery cell housing components.

18. The lithium ion battery of claim 16, further comprising, within an interior chamber formed between the first and second battery cell housing components, a negative electrode, a separator, a positive electrode, and an electrolyte.

19. The lithium ion battery of claim 18, wherein the negative electrode, the separator and the positive electrode are configured in a multilayered, rolled configuration.

20. The lithium ion battery of claim 19, comprising a cell diameter of about 7.9 mm and a cell height of about 3.6 mm, and comprising a capacity of at least 5 mAh.
